(19) United States
(12) Patent Application Publication
(10) Pub. No.: US 2012/0049131 A1
(43) Pub. Date: Mar. 1, 2012

(54) ELECTROCONDUCTIVE PASTE AND METHOD FOR FABRICATING THE SAME

(75) Inventors: Young Il LEE, Gyeonggi-do (KR); Seong Jin Kim, Gyeonggi-do (KR); Dong Hoon Kim, Gyeonggi-do (KR); Sung Eun Kim, Gyeonggi-do (KR)

(73) Assignee: SAMSUNG ELECTRO-MECHANICS CO., LTD.

(21) Appl. No.: 13/026,629

(22) Filed: Feb. 14, 2011

(30) Foreign Application Priority Data
Sep. 1, 2010 (KR) 10-2010-0085540

(51) Int. Cl. H01B 1/02

(52) U.S. Cl. 252/513; 252/512; 252/514

(57) ABSTRACT

Disclosed herein are an electroconductive paste and a method for fabricating the same. The electroconductive paste includes: metal nano powders having an aspect ratio of 1 to 2; and metal nano bars having an aspect ratio 3 to 300.

### CROSS REFERENCE(S) TO RELATED APPLICATIONS

This application claims the benefit under 35 U.S.C. Section [120, 119, 119(e)] of Korean Patent Application Serial No. 10-2010-0085540, entitled “Electroconductive Paste and Method for Fabricating the Same” filed on Sep. 1, 2010, which is hereby incorporated by reference in its entirety into this application.

### BACKGROUND OF THE INVENTION

1. Technical Field

The present invention relates to an electroconductive paste, and more particularly, to an electroconductive paste capable of preventing excessive contraction from being generated during sintering and a method for fabricating the same.

2. Description of the Related Art

Since an electroconductive paste containing metal powders has excellent conductivity, it has been widely used been as a material for an electrode and a circuit wiring of various electronic devices. Generally, the chief ingredients of the electroconductive paste are metal powders, an organic solvent, binders, and the like.

Recently, as the demand for a micro printed circuit wiring is increased due to the trend to make the electronic device slim and light, an electroconductive printed material for low temperature sintering to which metal nano powders are applied has been spotlighted. The metal nano powder based electroconductive printed material has excellent electrical characteristics at a low temperature, however, frequently generates a wiring crack due to characteristics of nano particles that are excessively contracted after being sintered and has a limitation in improving the densification degree of a film. Accordingly, in the case of forming the circuit wiring using the metal nano powder, a need exists for a method for preventing the wiring crack due to contraction after being sintered and improving the densification degree of the film.

### SUMMARY OF THE INVENTION

An object of the present invention is to provide an electroconductive paste capable of preventing a crack during forming of an electrode and a circuit wiring and improving the densification degree of a film and a method for fabricating the same.

According to an exemplary embodiment of the present invention, there is provided an electroconductive paste, including: metal nano powders; and metal nano bars having an aspect ratio higher than that of the metal nano powder.

According to another exemplary embodiment of the present invention, there is provided a method for fabricating an electroconductive paste, including: (A) fabricating electroconductive mixed powders including metal nano powders and metal nano bars having an aspect ratio higher than that of the metal nano powders; (B) adding binders and glass frits to an organic solvent to fabricate a mixed solution; and (c) adding the electroconductive mixed powders to the mixed solution and then agitating them to fabricate an electroconductive paste.

### BRIEF DESCRIPTION OF THE DRAWINGS

FIG. 1 is a scanning electron microscope (SEM) photograph of an electroconductive paste according to an exemplary embodiment of the present invention; and

FIG. 2 is a flow chart showing a method for fabricating an electroconductive paste according to an exemplary embodiment of the present invention.

### DESCRIPTION OF THE PREFERRED EMBODIMENTS

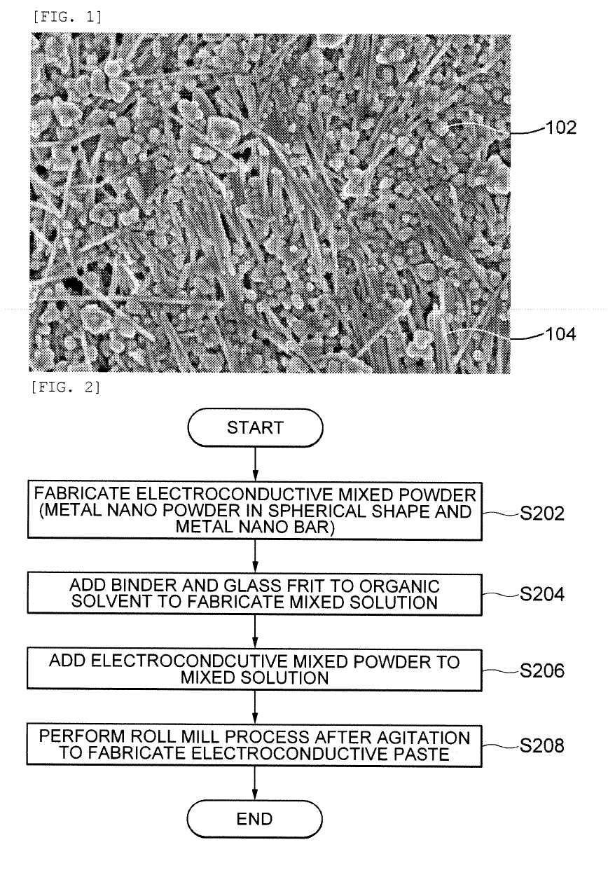

Hereinafter, detailed embodiments of an electroconductive paste and a method for fabricating the same according to the present invention will be described with reference to FIGS. 1 and 2. However, the embodiments set forth herein are only exemplary embodiments, and the present invention should not be construed as limited thereto.

In describing the present invention, when a detailed description of a well-known technology relating to the present invention may unnecessarily make the spirit of the present invention unclear, a detailed description thereof will be omitted. Further, the following terminologies are defined in consideration of the functions in the present invention and may be construed in different ways by the intention of users and operators. Therefore, the definitions thereof should be construed based on the contents throughout the specification.

The technical idea of the present invention is determined by the claims and the exemplary embodiments herein are provided so that the technical idea of the present invention will be efficiently explained to those skilled in the art to which the present invention pertains.

FIG. 1 is a scanning electron microscope (SEM) photograph of an electroconductive paste according to an exemplary embodiment of the present invention.

Referring to FIG. 1, an electroconductive paste according to an exemplary embodiment of the present invention includes metal nano powders 102 having a first aspect ratio and metal nano powders 104 having a second aspect ratio. Herein, the second aspect ratio means an aspect ratio higher than the first aspect ratio.

For example, a metal nano powder in a spherical shape may be used as the metal nano powder 102 having the first aspect ratio, and a metal nano powder in a bar shape (hereinafter, referred to as ‘metal nano bar’) may be used as the metal nano powder 104 having the second aspect ratio. Herein, the spherical shape is an example of a metal nano powder having a low aspect ratio (for example, 1 to 2), and should not be literally limited. In addition, the bar shape is an example of a metal nano powder having a high aspect ratio (for example, 3 to 300), and should not be literally limited.

In this case, it is possible to maintain the metal powder filling effect by nano particles through the metal nano powder 102 in a spherical shape and prevent excessive contraction after being sintered in the metal nano bar. A detailed description thereof will be provided below.

If the electroconductive paste is filled only with the metal nano powders 102 in a spherical shape, excessive contraction occurs during a sintering process. When a circuit wiring is formed using this electroconductive paste, a thickness thereof is reduced and a crack occurs therein.

That is, generally, in sintering the particles, particle growth occurs faster than densification in a low-temperature region, and the densification occurs faster than the particle growth in a high-temperature region. However, in the case of nano particles, it has very high interface energy, such that the densification rapidly progress before a sufficient particle growth occurs in the low temperature region during the sintering process, thereby causing a large sintering contraction. In addition, a strength with which the nano particles are agglomerated before sufficient particle growth occurs is strong, such that voids larger than the nano particles are generated. It is difficult to remove these large voids through sintering. These large voids progresses into gigantic voids or cracks in the future. Accordingly, when the circuit wiring is formed using this electroconductive paste, the thickness thereof is reduced and the crack occurs therein.

However, when mixing the metal nano powder 121 in a spherical shape with the metal nano bar 104 having a high aspect ratio (for example, 3 to 330), the contraction due to rapid densification of the nano particles is delayed to generate sufficient particle growth, thereby making it possible to prevent excessive contraction from occurring during the sintering process. In addition, the metal nano bar 104 obstructs a path in which the nano particles are agglomerated, thereby making it possible to prevent large voids from being generated.

Accordingly, when an electrode and the circuit wiring are formed using the electroconductive paste in which the metal nano powder 102 in a spherical shape and the metal nano bar 104 are mixed, it is possible to prevent the reduction in the thicknesses of the electrode and the circuit wiring, improve the densification degree of the film, and prevent the generation of a crack, thereby making it possible to implement excellent electrical characteristics.

Herein, as the metal nano powder 102 in a spherical shape, for example, a metal nano powder having the aspect ratio of 1 to 2 and the average particle size of 100 nm or less may be used. In addition, as the metal nano powder 102 in a spherical shape, one nano powder or two or more alloy nano powder selected form the group of metal consisting of gold, silver, copper, platinum, nickel, silicon, palladium, lead, tin, indium, aluminum, and the like, may be used.

Further, as the metal nano bar 104, for example, a metal nano bar having the aspect ratio of 3 to 300 may be used. At this time, the major axis of the metal nano bar 104 may be, for example 0.1 to 100 um, and the minor axis thereof may be, for example, 1 to 1000 nm.

Herein, when the aspect ratio of the metal nano bar 104 is below 3, sintering contraction at the same level as that of the metal nano powder occurs, such that a contraction prevention effect is not generated. In addition, when the aspect ratio of the metal nano bar 104 exceeds 300, low-temperature sintering characteristics due to the nano size disappear to deteriorate the sintering characteristics, thereby degrading electrical characteristics.

As the metal nano bar 104, one nano bar or two or more alloy nano bar selected form the group of metal consisting of gold, silver, copper, platinum, nickel, silicon, palladium, lead, tin, indium, aluminum, ant the like, may be used.

FIG. 2 is a flow chart showing a method for fabricating an electroconductive paste according to an exemplary embodiment of the present invention.

Referring to FIG. 2, an electroconductive mixed powder including metal nano powders in a spherical shape and metal nano bars is fabricated (S202). At this time, the metal nano bar is formed to have an aspect ratio of 3 to 300. Herein, the metal nano bar may be fabricated using a wet synthesis method. The aspect ratio of the metal nano bar may be adjusted by controlling a concentration ratio, a reaction time, a reaction temperature, and the like, of metal precursors and dispersants. For example, as an amount of dispersant becomes larger as compared with the metal precursor, the length of the metal nano bar may be enlarged in a length direction, and when the reaction time is extended under the same condition, the length of the metal nano bar may be enlarged.

Then, binders and glass frits are added to an organic solvent to fabricate a mixed solution (S204). The organic solvent allows the electroconductive paste to have excellent dispersion characteristics. As the organic solvent, for example, terpineol, dihydroterpineal, dihydroterpineal acetate, ethylcarbitol, ethycarbitol acetate, butylcarbitol, butylcarbitol acetate, and the like, may be used.

The binder allows the electoconductive paste to have viscosity and attaches each component within the electroconductive paste. As the binder, for example, a cellulose based resin such as ethylcellulose, nitrocellulose, and the like, or an acryl based resin, or the like, may be used.

The glass frit is an organic additive for implementing attaching characteristics and other intended functions. The may be composed of one or a mixture of two or more selected from a group consisting of SiO₂, B₂O₃, PbO, Bi₂O₃, Al₂O₃, ZnO, Ag₂O), and the like.

Thereafter, the electroconductive mixed powder composed of the metal nano powder in a spherical shape and the metal nano bar is added to the mixed solution (S206). At this time, the content of the metal nano bar within the electroconductive mixed powder may be 0.1 to 50 wt %.

Then, after uniformly agitating the mixed solution and the electroconductive mixed powder, a roll mill process is performed to fabricate the electroconductive paste (S208).

Meanwhile, although it is described herein that the mixed solution the mixed solution is fabricated after the metal nano powder in a spherical shape and the metal nano bar are fabricated, the metal nano powder in a spherical shape and the metal nano bar may be fabricated after the mixed solution is fabricated.

### Example 1

Ethylcellulose (10 mPa·s) was added to 11 g of alpha terpineol, which is an organic solvent, and heated and dissolved. Then, a small amount of a glass frit, which is an inorganic additive, was added thereto to fabricate a mixed solution. 33 g of electroconductive mixed powder composed of 20 wt % of a silver nano bar having an aspect ratio of 60 and a remainder silver nano powder having an average diameter of 40 nm were added to the mixed solution. Thereafter, the mixed solution and the electroconductive mixed powder were uniformly mixed using an agitator, and then were passed through a 3-roll mill several times to fabricate an electroconductive paste. Then, a micro wiring having a width of 100 um and a length of 10 cm was printed on a glass substrate using a screen printer to confirm discharging performance of the printing. Thereafter, the printed micro wiring was subjected to a drying process and was sintered for 60 minutes at a temperature of 250° C. Electrical characteristics were evaluated.

### Example 2

Ethylcellulose (10 mPa·s) was added to 11 g of alpha terpineol, which is an organic solvent, and heated and dissolved. Then, a small amount of a glass frit, which is an inorganic additive, was added thereto to fabricate a mixed solution. 33 g of electroconductive mixed powder composed of 20 wt % of a silver nano bar having an aspect ratio of 40 and a remainder silver nano powder having an average diameter of 40 nm were added to the mixed solution Thereafter, the mixed solution and the electroconductive mixed powder were uniformly mixed using an agitator, and then were passed through a 3-roll mill several times to fabricate an electroconductive paste. Then, a micro wiring having a width of 100 um and a length of 10 cm was printed on a glass substrate using a screen printer to confirm discharging performance of the printing. Thereafter, the printed micro wiring was subjected to a drying process and was sintered for 60 minutes at a temperature of 500° C. Electrical characteristics were evaluated.

### Comparative Example 1

Ethylcellulose (10 mPa·s) was added to 11 g of alpha terpineol, which is an organic solvent, and heated and dissolved. Then, a small amount of a glass frit, which is an inorganic additive, was added thereto to fabricate a mixed solution. 33 g of silver nano powder having an average diameter of 40 nm were added to the mixed solution, were uniformly mixed using an agitator, and then were passed through a 3-roll mill several times to fabricate an electroconductive paste. Then, a micro wiring having a width of 10 um and a length of 10 cm was printed on a glass substrate using a screen printer to confirm discharging performance of the printing. Thereafter, the printed micro wiring was subjected to a drying process and was sintered for 60 minutes at a temperature of 250° C. Electrical characteristics were evaluated.

### Comparative Example 2

Ethylcellulose (10 mPa·s) was added to 11 g of alpha terpineol, which is an organic solvent, and heated and dissolved. Then, a small amount of a glass frit, which is an inorganic additive, was added thereto to fabricate a mixed solution. 33 g of silver nano powder having an average diameter of 40 nm were added to the mixed solution, were uniformly mixed using an agitator, and then were passed through a 3-roll mill several times to fabricate an electroconductive paste. Then, a micro wiring having a width of 100 um and a length of 10 cm was printed on a glass substrate using a screen printer to confirm discharging performance of the printing. Thereafter, the printed micro wiring was subjected to a drying process and was sintered for 60 minutes at a temperature of 500° C. Electrical characteristics were evaluated.

In Table 1, the characteristics of the electroconductive pastes according to Examples 1 and 2 and Comparative Examples 1 and 2 are compared. Herein, each indicates: x: no crack, Δ: slight crack, ∘: serious crack, and □: very serious crack.

TABLE 1

| | Metal | | Crack After | Sintering | Contraction | Crack | |
|---|---|---|---|---|---|---|---|
| | Aspect | Content | Drying Printed | Temperature | Ratio | After | Resistivity |
| | Ratio | (wt %) | Micro Wiring | (° C.) | (%) | Firing | (μΩ · cm) |
| Example 1 | 60 | 20 | x | 250 | 30 | x | 5.7 |
| Example 2 | 40 | 20 | x | 500 | 40 | x | 5.7 |
| Comparative | — | — | □ | 250 | 40 | ∘ | 11 |
| Example 1 | | | | | | | |
| Comparative | — | — | □ | 500 | 60 | □ | — |
| Example 2 | | | | | | | |

Referring to Table 1, in the case of Example 1, it can be appreciated that a crack was not generated after drying the printed wiring, contraction ratio during sintering corresponds to 30%, and a crack was not generated after firing. On the other hand, in the case of Comparative Example 1, it can be appreciated that a crack was slightly generated after drying the printed wiring, contraction ratio during sintering corresponds to 40%, and a crack was seriously generated after firing. In addition, it can be appreciated that resistivity was lower about 2 times in the case of Example 1 than that in the case of Comparative Example 1.

Further, in the case of Example 2, it can be appreciated that a crack was not generated after drying the printed wiring, contraction ratio during sintering corresponds to 40%, and the crack was not generated after firing. On the other hand, in the case of Comparative Example 2, it can be appreciated that a crack was slightly generated after drying the printed wiring, contraction ratio during sintering corresponds to 60%, and a crack was very seriously generated after firing.

As such, according to the exemplary embodiments of the present invention, it is possible to reduce the contraction ratio during sintering and prevent the generation of a crack after firing. Accordingly, when the electrode and the circuit wiring are formed using the electroconductive paste according to the exemplary embodiments of the present invention, it is possible to prevent the reduction in the thickness of the electrode and the circuit, improve the densification degree of the film and implement excellent electrical characteristics.

According to the exemplary embodiments of the present invention, the metal nano bar having the high aspect ratio is added to the electroconductive paste, thereby making it possible to prevent excessive contraction from being generated during the sintering process, prevent the thickness of the circuit wiring from being reduced, and prevent a crack from being generated.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

Accordingly, the scope of the present invention is not construed as being limited to the described embodiments but is defined by the appended claims as well as equivalents thereto.

What is claimed is:

1. An electroconductive paste, comprising:
metal nano powders; and
metal nano bars having an aspect ratio higher than that of the metal nano powder.

2. The electroconductive paste according to claim 1, wherein the aspect ratio of the metal nano bars is 3 to 300.

3. The electroconductive paste according to claim 1, wherein the aspect ratio of the metal nano powders is 1 to 2.

4. The electroconductive paste according to claim 1, wherein the metal nano powder and the metal nano bar are composed of one or two or more metals selected form the group of metal consisting of gold, silver, copper, platinum, nickel, silicon, palladium, lead, tin, indium, aluminum.

5. A method for fabricating an electroconductive paste, comprising:
(A) fabricating electroconductive mixed powders including metal nano powders and metal nano bars having an aspect ratio higher than that of the metal nano powders;
(B) adding binders and glass frits to an organic solvent to fabricate a mixed solution; and
(c) adding the electroconductive mixed powder to the mixed solution and then agitating them to fabricate an electroconductive paste.

6. The method for fabricating an electroconductive paste according to claim 5, wherein at step (A), the aspect ratio of the metal nano powder is 1 to 2 and the aspect ratio of the metal nano bar is 3 to 300.

7. The method for fabricating an electroconductive paste according to claim 6, wherein at step (A), the metal nano powder and the metal nano bar are fabricated by a wet synthesis method.

8. The method for fabricating an electroconductive paste according to claim 7, wherein the aspect ratio of the metal nano bar is adjusted by controlling at least one of a concentration ratio, a reaction time, and a reaction temperature of metal precursors and dispersants.

9. The method for fabricating an electroconductive paste according to claim 5, wherein the content of the metal nano bar within the electroconductive mixed powder is 0.1 to 50 wt %.

10. An electrode formed using an electroconductive paste according to any one of claims 1 to 4.
